(19) United States
(12) Patent Application Publication
(10) Pub. No.: US 2016/0115867 A1
(43) Pub. Date: Apr. 28, 2016

(54) WATER DELIVERY SYSTEM FOR GAS TURBINE COMPRESSOR

(71) Applicant: General Electric Company, Schenectady, NY (US)

(72) Inventors: Hua Zhang, Greer, SC (US); Douglas Scott Byrd, Greer, SC (US); Wei Ning, Cincinnati, OH (US); Joshua Shane Sater, Anderson, SC (US)

(21) Appl. No.: 14/524,242

(22) Filed: Oct. 27, 2014

(51) Int. Cl. F02C 3/30; F02C 9/16; F01K 23/06

(52) U.S. Cl. CPC F02C 3/30; F01K 23/06; F02C 9/16; F05D 2220/62

(57) ABSTRACT

A water delivery system for a gas turbine compressor having a plurality of blade stages positioned about a rotating shaft is provided. The plurality of blade stages are configured to compress an airflow. The water delivery system includes a nozzle system to inject water between at least one pair of the plurality of blade stages; and a controller controlling whether the water injected by the nozzle system is injected at a first pressure that augments power output during an operation mode of the plurality of blade stages and a second, lower pressure that washes at least some of blades of the plurality of blade stages during a wash mode of the plurality of blade stages.

### BACKGROUND OF THE INVENTION

The disclosure relates generally to compressors, and more particularly, to a water delivery system for a gas turbine compressor, and a gas turbine and combined cycle power plant including the same.

Gas turbines are used in conjunction with a generator to create electric power in a wide variety of settings. Gas turbines, however, exhibit lower power output and lower efficiency in hot environments, a situation in which power is oftentimes in peak demand. In addition, gas turbines are called upon to make rapid increases in power generation when an increase in demand occurs in the electric grid to which they are coupled. An increase in electric demand can occur for a number of reasons such as the grid's renewable energy elements quickly decreasing output. One approach to augment power generation in a gas turbine is to inject water into an inlet of a compressor system upstream of the rotating blades of the compressor, or in an intermediate stage of the compressor. The water injection and evaporation inside the compressor cools the airflow which enables the compressor to compress more mass flow with less work, resulting in the instantaneous generation of more power in the gas turbine (e.g., up to 30MW). In this mode of operation, the water droplet size is typically smaller than 20 micrometers because larger water droplets can damage the blades during an operating mode of the compressor.

Water may also be injected into an inlet of a gas turbine compressor upstream of the rotating blades as part of a maintenance step to clean buildup from early stages of the blades of the compressor. The water cleaning acts to remove the buildup on the blades, thus improving performance of the compressor. One challenge regarding the cleaning, however, is that a conventional water wash is not capable of cleaning downstream stages of the compressor blades. In the cleaning mode, large sized water droplets are used to clean the buildup, e.g., droplets greater than 20 micrometers. The large sized water droplets are not effective for increasing power output because they may not evaporate and cool the airflow inside the compressor.

### BRIEF DESCRIPTION OF THE INVENTION

A first aspect of the disclosure provides a water delivery system for a gas turbine compressor having a plurality of blade stages positioned about a rotating shaft, the plurality of blade stages configured to compress an airflow, the water delivery system comprising: a nozzle system to inject water between at least one pair of the plurality of blade stages; and a controller controlling whether the water injected by the nozzle system is injected at a first pressure that augments power output during an operation mode of the plurality of blade stages and a second, lower pressure that washes at least some of blades of the plurality of blade stages during a wash mode of the plurality of blade stages.

A second aspect of the disclosure provides a compressor for a gas turbine, the compressor comprising: a plurality of blade stages positioned about a rotating shaft, the plurality of blade stages configured to compress an airflow; a nozzle system to inject water between at least one pair of the plurality of blade stages; and a controller controlling whether the water injected by the nozzle system is injected at a first pressure that augments power output during an operation mode of the plurality of blade stages and a second, lower pressure that washes at least some of blades of the plurality of blade stages during a wash mode of the plurality of blade stages.

A third aspect of the disclosure provides a combined cycle power plant comprising: a steam turbine system; a heat recovery steam generator operably coupled to the steam turbine system; a gas turbine operably coupled to the steam turbine system, the gas turbine including a combustor; and a compressor operably coupled to the combustor of the gas turbine, the compressor including: a plurality of blade stages positioned about a rotating shaft, the plurality of blade stages configured to compress an airflow, a nozzle system to inject water between at least one pair of the plurality of blade stages, and a controller controlling whether the water injected by the nozzle system is injected at a first pressure that augments power output during an operation mode of the plurality of blade stages and a second, lower pressure that washes at least some of blades of the plurality of blade stages during a wash mode of the plurality of blade stages.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of one embodiment of a water delivery system for a gas turbine compressor according to the invention.

FIG. 2 shows a cross-sectional view of an illustrative intermediate stage of a gas turbine compressor according to embodiments of the invention.

FIG. 3 shows a detailed cross-sectional view of a nozzle of the water delivery system according to embodiments of the invention.

FIG. 4 shows a schematic view of an alternative embodiment of a water delivery system for a gas turbine compressor according to the invention.

FIG. 5 shows a schematic view of another alternative embodiment of a water delivery system for a gas turbine compressor according to the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a water delivery system for a gas turbine compressor. The water delivery system provides wet compression and water wash in a combined fashion despite their conflicting requirements.

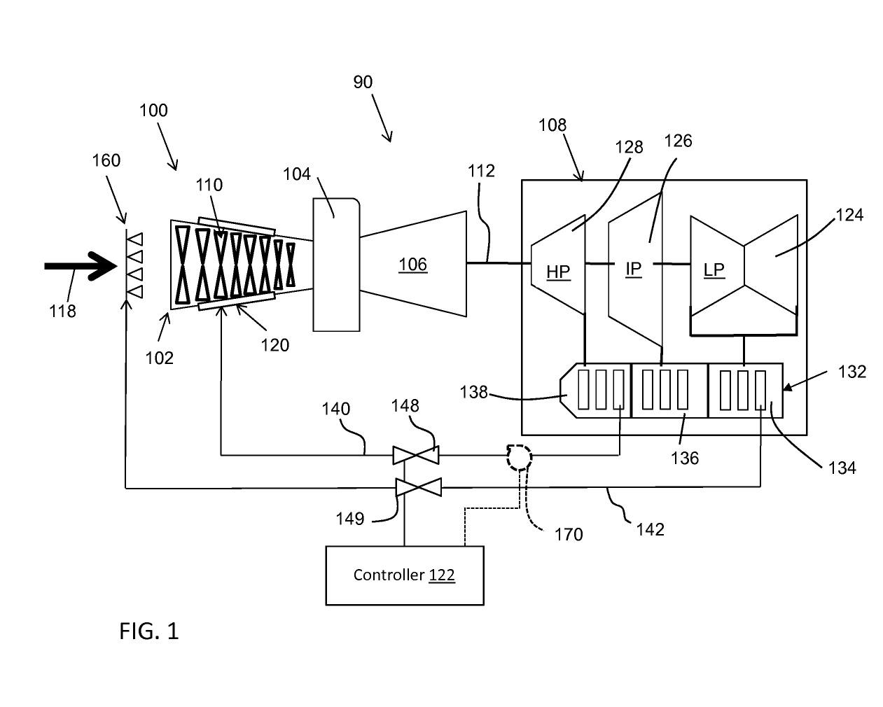

Referring to FIG. 1, a schematic view of a combined cycle power plant 90 incorporating embodiments of a water delivery system 100 for a gas turbine compressor 102 according to embodiments of the invention is illustrated. While embodiments of the invention will be described in the setting of a combined cycle power plant 90, it is emphasized that the teachings thereof find applicability in a wide variety of alternative settings, e.g., a system without a steam turbine system. Generally, combined cycle power plant 90 may include a steam turbine system 108, and a heat recovery steam generator (HRSG) 132 operably coupled to steam turbine system 108 in a known fashion. In addition, plant 90 includes a gas turbine 106 operably coupled to steam turbine system 108, the gas turbine including a combustor 104. A compressor 102 for providing a compressed airflow is operably coupled to combustor 104 of gas turbine 106.

Gas turbine compressor 102 feeds an airflow 118 to combustor 104 for gas turbine 106. As illustrated, gas turbine 106 is coupled to steam turbine system 108. Gas turbine compressor 102 includes a plurality of blade stages 110 positioned about a rotating shaft 112. While a particular number of blade stages 110 has been illustrated, i.e., 8, it is understood that more or fewer stages may be provided. As is customary, and as will be described elsewhere herein, each blade stage 110 includes a set of rotating blades and a set of stationary vanes. Rotating shaft 112 may couple compressor 102, gas turbine 106 and steam turbine system 108; however, gas turbine 106 and steam turbine system 108 may be on separate rotating shafts, if desired. Plurality of blade stages 110 are configured to compress an airflow 118 for delivery to combustor 104, in a known fashion. Gas turbine 106 and steam turbine system 108 may be coupled to generator(s) (not shown) to generate power from their operation in a known fashion.

In accordance with embodiments of the invention, water delivery system 100 may include a nozzle system 120 to inject water between at least one pair of plurality of blade stages 110, e.g., at a stationary vane area between two adjacent sets of rotating blades. As will be described herein, nozzle system 120 includes a variety of pipes, valves, nozzles, etc., providing this functionality. Water delivery system 100 also includes a controller 122 controlling whether the water injected by nozzle system 120 is injected at a first pressure that augments power output during an operation mode of plurality of blade stages 110 and a second, lower pressure that washes at least some of blades of plurality of blade stages 110 during a wash mode of the plurality of blade stages.

In the FIG. 1 embodiment, the water for water delivery system 100 may be sourced from steam turbine system 108, which may include, for example, a low pressure (LP) steam turbine 124, an intermediate pressure (IP) steam turbine 126 and a high pressure (HP) steam turbine 128. Water for nozzle system 120 may be sourced, for example, from HP steam turbine 128 via a heat recovery steam generator 132. Heat recovery steam generator (HRSG) 132 may include a low pressure recovery section 134, an intermediate pressure recovery section 136 and a high pressure recovery section 138. As is conventional, each recovery section 134, 136, 138 may include a superheater portion that recovers steam, an evaporator portion that recovers steam and water, and an economizer that recovers just water. The water for nozzle system 120 may be sourced, for example, from HP steam turbine 128 via HRSG 132. For example, the water may be sourced from an economizer of HP recovery section 138 of HRSG 132. Controller 122 controls whether water from HP steam turbine 128 is delivered at the first pressure to nozzle system 120 or the second, lower pressure via nozzle system 120. Controller 122 may provide this control using a wide variety of mechanisms such as controlling a valve 148 in piping 140 that delivers water to nozzle system 120. In an alternative embodiment, a pump 170 (shown in phantom in FIG. 1) may be controlled by controller 122 to determine whether the first pressure or second pressure water is delivered to nozzle system 120. Pump 170 may be employed as an alternative or in addition to valve(s) 148. If provided, a variable frequency drive of pump 170 may be controlled by controller 122 in order to control whether the water injected by nozzle system 120 is injected at the first pressure or the second, lower pressure.

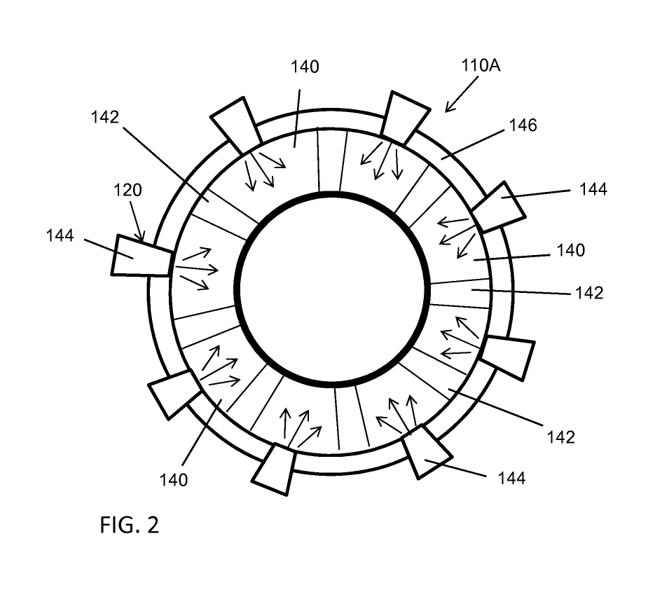

Referring to FIG. 2, a cross-sectional view of an illustrative intermediate stage 110A of gas turbine compressor 102 (FIG. 1) according to embodiments of the invention is illustrated. Stage 110A may be any stage of plurality of blade stages 110 other than a first, second, penultimate or last stage. For example, in a fourteen stage compressor, stage 110A may be any stage between 3 and 12. As shown in FIG. 2, each blade stage 110 includes a set of rotating blades 140 and a set of stationary vanes 142. Rotating blades 140 are in a plane next to stationary vanes 142, as illustrated in FIG. 2.

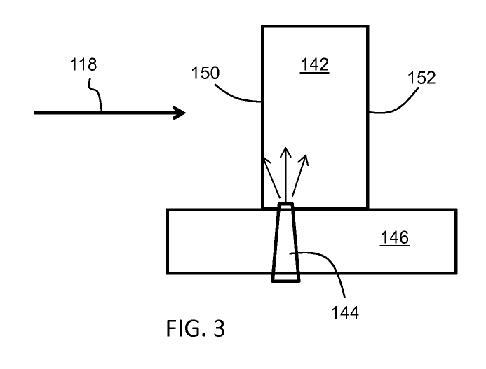

In one embodiment, nozzle system 120 includes a nozzle 144 disposed between each pair of stationary vanes 142 of stage 110A. That is, a nozzle 144 is disposed between each circumferentially spaced vane 142 with each nozzle 144 being disposed through or within a casing 146 of compressor 102 (FIG. 1). Each nozzle 144 may include any now known or later developed nozzle structure capable of spraying water droplets into a fluid flow within compressor 102 at variable pressures resulting in a varied water droplet size. Referring to FIG. 3, in one embodiment, in order to ensure proper distribution and delivery of water, each nozzle 144 may be disposed nearer to a leading edge 150 of a respective stationary vane 142 than a trailing edge 152 of the stationary vane. It is understood that the number of vanes and nozzles illustrated in FIG. 2 is illustrative only, and should not be considered limiting of the invention as a wide variety of different arrangements are possible.

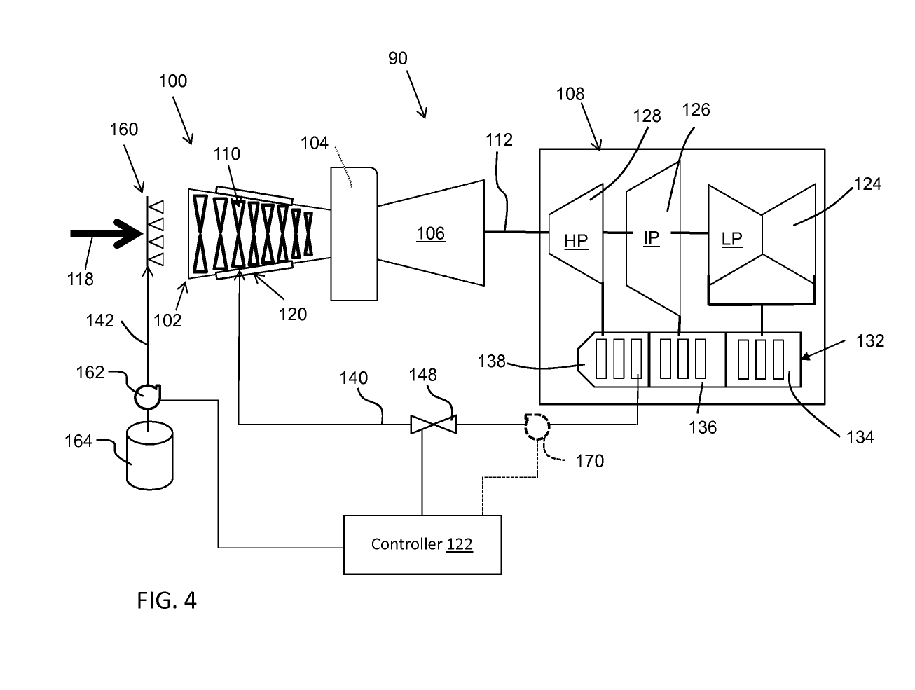

With reference to FIGS. 1 and 4, a wetting system 160 may also be provided to inject water into airflow 118 upstream of plurality of blade stages 110. Although illustrated schematically as a nozzle type system, wetting system 160 may include any now known or later developed nozzle system or evaporative cooling system. An evaporative cooling system may include any medium capable of being wetted and allowing airflow 118 to pass therethrough to moisturize and cool airflow 118. If in the form of nozzles, the nozzles may be arranged in a ring about an inlet of compressor 102, e.g., a bellmouth inlet, etc. As illustrated in FIG. 1, in one embodiment as described herein, the water injected by nozzle system 120 may be sourced from high pressure steam turbine 128 via HRSG 132. The pressure, flow rate and thus size of water droplets provided to nozzle system 120 from HP steam turbine 128 may be controlled by controller 122. In contrast, the water injected by wetting system 160 may be sourced from a low pressure steam turbine 124 via HRSG 132, under control of controller 122. For example, from an LP steam turbine economizer of HRSG 132. The water may be delivered to wetting system 160 using any now known or later developed piping 142, which may include a valve 149 controlled by controller 122. Hence, the water delivered to wetting system 160 is lower pressure than that delivered to nozzle system 120.

In an alternative embodiment, shown in FIG. 4, water injected by nozzle system 120 may be sourced from high pressure steam turbine 128 via HRSG 132, and the water injected by wetting system 160 may be sourced by a pump 162 from a water reservoir 164. Water reservoir 164 may be any water source within combined cycle power plant 90, e.g., a condenser reservoir, etc. Pump 162, e.g., a variable frequency drive thereof, may be controlled by controller 122 in a conventional manner.

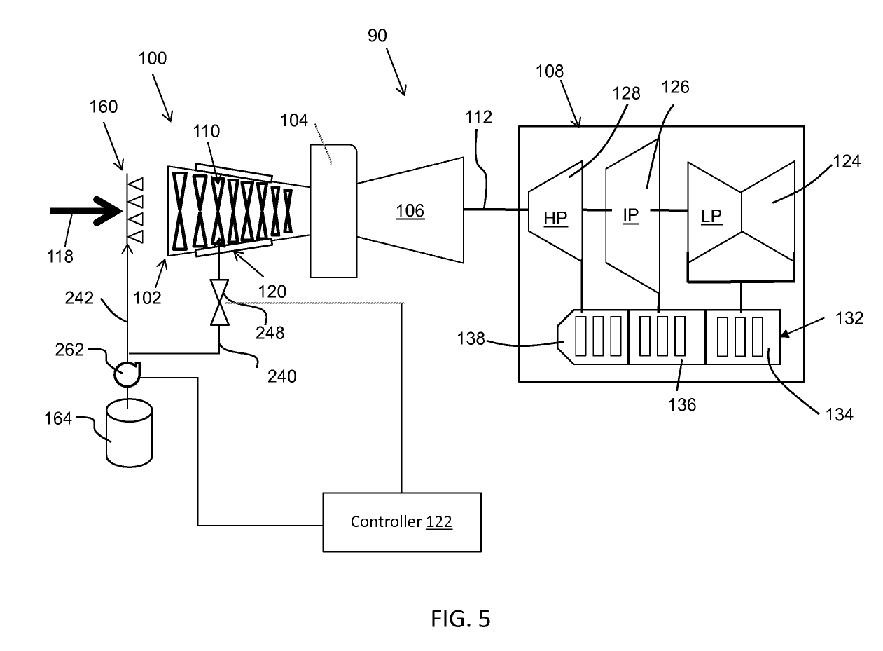

In yet another alternative embodiment, shown in FIG. 5, water injected by nozzle system 120 and the water injected by wetting system 160 both may be sourced by a pump 262 from a water reservoir 164, e.g., via piping 240, 242, respectively. Again, water reservoir 164 may be any water source within combined cycle power plant 90, e.g., a condenser reservoir, etc. Pump 162, e.g., a variable frequency drive thereof, may be controlled by controller 122 in a conventional manner. The water injected by nozzle system 120 may also be controlled by a valve 248 independently from pump 262 to provide the first pressure or second pressure water.

In an operation mode, with power augmentation, controller 122 provides water for injection by nozzle system 120 at the first pressure that creates a super fine spray for power augmentation. As used herein, “super fine spray” indicates a water droplet size distribution of 20 microns at DV90, e.g., 90% of volume of water having droplet size smaller than 30 microns. The first pressure may be in the range of approximately 13.7 MegaPascal (MPa) to approximately 17.9 MPa. As an alternative, simultaneously to nozzle system 120 delivering water to intermediate stages 110A of blade stages 110, wetting system 160 may be delivering water upstream of stages 110 to provide further augmentation. Wetting system 160 may also operate without nozzle system 120, if desired. In a wash mode for intermediate stage 110A and later stages of compressor 102, controller 122 provides water for injection by nozzle system 120 at the second, lower pressure. At the second, lower pressure, water droplet size may be in the range of approximately 100 microns to approximately 200 microns. The second pressure may be in the range of approximately 1.2 MPa to approximately 2.5 MPa. Wetting system 160 would typically be inoperative during the wash mode.

Water delivery system 100 provides preventive maintenance via the wash mode and efficiency recovery during the operation mode for older machines. A rapid increase in power output using first pressure of water delivery system 100 may be, for example, up to approximately 20%, while system 100 also allows cleaning of intermediate blade stages 110A in the wash mode without additional structure. In addition, water delivery system 100 may lower nitrous oxide (NOx) emission in the operation mode. Finally, water delivery system 10 may lower gas turbine firing temperatures, providing longer hot gas path parts life.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A water delivery system for a gas turbine compressor having a plurality of blade stages positioned about a rotating shaft, the plurality of blade stages configured to compress an airflow, the water delivery system comprising:
a nozzle system to inject water between at least one pair of the plurality of blade stages; and
a controller controlling whether the water injected by the nozzle system is injected at a first pressure that augments power output during an operation mode of the plurality of blade stages and a second, lower pressure that washes at least some of blades of the plurality of blade stages during a wash mode of the plurality of blade stages.

2. The water delivery system of claim 1, wherein the water at the first pressure is sourced from a low pressure steam turbine via a heat recovery steam generator, and the water at the second pressure is sourced from a high pressure steam turbine via the heat recovery steam generator.

3. The water delivery system of claim 1, further comprising a wetting system to inject water into the airflow upstream of the plurality of blade stages.

4. The water delivery system of claim 3, wherein the water injected by the nozzle system is sourced from a high pressure steam turbine via a heat recovery steam generator, and the water injected by the wetting system is sourced by a pump from a water reservoir.

5. The water delivery system of claim 3, wherein the water injected by the nozzle system is sourced from a high pressure steam turbine via a heat recovery steam generator, and the water injected by the wetting system is sourced from a low pressure steam turbine via the heat recovery steam generator.

6. The water delivery system of claim 3, wherein the wetting system includes an evaporative cooling system.

7. The water delivery system of claim 1, wherein each blade stage includes a set of rotating blades and a set of stationary vanes, and the nozzle system includes a nozzle disposed between each pair of the stationary vanes.

8. The water delivery system of claim 7, wherein each nozzle is disposed nearer to a leading edge of the stationary vanes than a trailing edge of the stationary vane.

9. The water delivery system of claim 1, wherein each blade stage includes a set of rotating blades and a set of stationary vanes, and the nozzle system includes a nozzle disposed nearer to a trailing edge of the stationary vanes than a leading edge of the stationary vane.

10. The water delivery system of claim 1, wherein the water injected by the nozzle system during the operation mode includes a super fine spray.

11. The water delivery system of claim 1, wherein the controller controls at least one of a control valve and a variable frequency drive of a pump that delivers the water in order to control whether the water injected by the nozzle system is injected at the first pressure or the second pressure.

12. A compressor for a gas turbine, the compressor comprising:
a plurality of blade stages positioned about a rotating shaft, the plurality of blade stages configured to compress an airflow;
a nozzle system to inject water between at least one pair of the plurality of blade stages; and
a controller controlling whether the water injected by the nozzle system is injected at a first pressure that augments power output during an operation mode of the plurality of blade stages and a second, lower pressure that washes at least some of blades of the plurality of blade stages during a wash mode of the plurality of blade stages.

13. The compressor of claim 12, wherein the water at the first pressure is sourced from a low pressure steam turbine via a heat recovery steam generator, and the water at the second pressure is sourced from a high pressure steam turbine via the heat recovery steam generator.

14. The compressor of claim 12, further comprising a wetting system to inject water into the airflow upstream of the plurality of blade stages.

15. The compressor of claim 14, wherein the water injected by the nozzle system is sourced from a high pressure steam turbine via a heat recovery steam generator, and the water injected by the wetting system is sourced by a pump from a water reservoir.

16. The compressor of claim 14, wherein the water injected by the nozzle system is sourced from a high pressure steam turbine via a heat recovery steam generator, and the water injected by the wetting system is sourced from a low pressure steam turbine via the heat recovery steam generator.

17. The compressor of claim 12, wherein each blade stage includes a set of rotating blades and a set of stationary vanes, and the nozzle system includes a nozzle disposed between each pair of the stationary vanes.

18. The compressor of claim 17, wherein each nozzle is disposed nearer to a leading edge of the stationary vanes than a trailing edge of the stationary vane.

19. The compressor of claim 1, wherein the controller controls at least one of a control valve and a variable frequency drive of a pump that delivers the water in order to control whether the water injected by the nozzle system is injected at the first pressure or the second pressure.

20. A combined cycle power plant comprising:
a steam turbine system;
a heat recovery steam generator operably coupled to the steam turbine system;
a gas turbine operably coupled to the steam turbine system, the gas turbine including a combustor; and
a compressor operably coupled to the combustor of the gas turbine, the compressor including:
a plurality of blade stages positioned about a rotating shaft, the plurality of blade stages configured to compress an airflow,
a nozzle system to inject water between at least one pair of the plurality of blade stages, and
a controller controlling whether the water injected by the nozzle system is injected at a first pressure that augments power output during an operation mode of the plurality of blade stages and a second, lower pressure that washes at least some of blades of the plurality of blade stages during a wash mode of the plurality of blade stages.
